(19) United States
(12) Patent Application Publication
(10) Pub. No.: US 2026/0155430 A1
(43) Pub. Date: Jun. 4, 2026

(54) SECONDARY BATTERY AND METHOD FOR MANUFACTURING THE SAME

(71) Applicant: SK On Co., Ltd., Seoul (KR)

(72) Inventors: Hyun Seop SHIN, Daejeon (KR); Kyeong Joon KIM, Daejeon (KR); Seung Hwan LEE, Daejeon (KR); Eun Jeong YI, Daejeon (KR)

(21) Appl. No.: 19/406,965

(22) Filed: Dec. 3, 2025

(30) Foreign Application Priority Data
Dec. 4, 2024 (KR) 10-2024-0178187

(51) Int. Cl. H01M 10/0525; H01M 4/02; H01M 10/0562; H01M 10/0585

(52) U.S. Cl. CPC H01M 10/0525; H01M 10/0562; H01M 10/0585; H01M 2004/021

(57) ABSTRACT

Provided is a secondary battery including: an electrode including a current collector, and an active material layer on at least any one surface of the current collector; and a solid electrolyte layer on at least any one surface of the active material layer, wherein a thickness (D₁) of the electrode and a thickness (D₂) of the solid electrolyte layer on any one surface of the active material layer satisfy the following Equation 1, and an area (A_{ε}) of the active material layer on any one surface of the current collector and an area (A_{S}) of the solid electrolyte layer on any one surface of the active material layer satisfy the following Equation 2:

$${D}_{2} / {D}_{1} \leq 1.5 \qquad [ Equation 1 ]$$

$$0.3 \leq {A}_{E} / {A}_{S} < 1. \qquad [ Equation 2 ]$$

### CROSS-REFERENCE TO RELATED APPLICATIONS

This application claims priority under 35 U.S.C. § 119 to Korean Patent Application No. 10-2024-0178187, filed on Dec. 4, 2024, in the Korean Intellectual Property Office, the disclosure of which is incorporated herein by reference in its entirety.

### TECHNICAL FIELD

The following disclosure relates to a secondary battery and a method for manufacturing the same.

### BACKGROUND

In recent years, battery development has been given importance, together with rapid spread of information-related device or communication devices such as cameras and mobile phones. In addition, development of a high-power or high-capacity battery for electric or hybrid vehicles is progressing, in the automobile industry and the like as well.

Since a commercially available lithium ion battery uses an electrolyte solution including a flammable organic solvent, improvement of a structure or material for installation of safety devices to suppress a temperature increase during short circuit or prevention of short circuits is needed. For this, since an all-solid-state battery in which an electrolyte solution is changed into a solid electrolyte layer and a battery is made in an all solid state does not use a flammable organic solvent in the battery, simplification of safety devices is promoted and manufacturing costs and productivity are excellent.

### SUMMARY

An embodiment of the present disclosure is directed to providing a secondary battery including a structure in which a solid electrolyte layer is provided on an upper portion of an electrode.

Another embodiment of the present disclosure is directed to providing a method for manufacturing a secondary battery including a structure in which a solid electrolyte layer is provided on an upper portion of an electrode.

In one general aspect, a secondary battery includes: an electrode including a current collector, and an active material layer on at least any one surface of the current collector; and a solid electrolyte layer on at least any one surface of the active material layer, wherein a thickness (D₁) of the electrode and a thickness (D₂) of the solid electrolyte layer on any one surface of the active material layer satisfy the following Equation 1:

$${D}_{2} / {D}_{1} \leq 1.5 , \qquad [ Equation 1 ]$$

and an area (A_{ε}) of the active material layer on any one surface of the current collector and an area (A_{S}) of the solid electrolyte layer on any one surface of the active material layer satisfy the following Equation 2:

$$0.3 \leq {A}_{E} / {A}_{S} < 1. \qquad [ Equation 2 ]$$

In an exemplary embodiment, the thickness (D₂) of the solid electrolyte layer on any one surface of the active material layer may be 5 μm to 500 μm.

In an exemplary embodiment, the thickness (D₁) of the electrode may be 10 μm to 1,000 μm.

In an exemplary embodiment, the thickness (D₁) of the electrode and the thickness (D₂) of the solid electrolyte layer on any one surface of the active material layer may satisfy the following Equation 1-1:

$$0.005 \leq {D}_{2} / {D}_{1} \leq 1.5 . \qquad [ Equation 1 - 1 ]$$

In an exemplary embodiment, the thickness (D₁) of the electrode and the thickness (D₂) of the solid electrolyte layer on any one surface of the active material layer may satisfy the following Equation 1-2:

$$0.005 \leq {D}_{2} / {D}_{1} \leq 1. . \qquad [ Equation 1 - 2 ]$$

In an exemplary embodiment, the area (A_{ε}) of the active material layer on any one surface of the current collector and the area (A_{S}) of the solid electrolyte layer on any one surface of the active material layer may satisfy the following Equation 2-1:

$$0.4 \leq {A}_{E} / {A}_{S} < 1. \qquad [ Equation 2 - 1 ]$$

In an exemplary embodiment, the secondary battery may further satisfy the following Equation 3:

$$0.5 \leq ( {A}_{E} / {A}_{S} ) / ( {D}_{2} / {D}_{1} ) \leq 200. \qquad [ Equation 3 ]$$

In an exemplary embodiment, the solid electrolyte layer may be provided on an upper portion and a side portion of any one surface or both surfaces of the electrode, and more specifically, may be provided on the upper portion and the side portion of the active material layer.

In an exemplary embodiment, the secondary battery may include a structure 1-1 including a positive electrode including a positive electrode current collector and a positive electrode active material layer on both surfaces of the positive electrode current collector, and the solid electrolyte layer provided on both surfaces of the positive electrode; and a structure 2-1 including a negative electrode current collector and a negative electrode active material layer on both surfaces of the negative electrode current collector, wherein the structure 1-1 and the structure 2-1 may be alternately and repeatedly laminated.

In an exemplary embodiment, the secondary battery may include a structure 1-2 including a positive electrode current collector and a positive electrode active material layer on both surfaces of the positive electrode current collector; and a structure 2-2 including a negative electrode including a negative electrode current collector and a negative electrode active material layer on both surfaces of the negative electrode current collector, and the solid electrolyte layer provided on both surfaces of the negative electrode, wherein the structure 1-2 and the structure 2-2 may be alternately and repeatedly laminated.

In an exemplary embodiment, the secondary battery may include a structure 1-1 including a positive electrode including a positive electrode current collector and a positive electrode active material layer on both surfaces of the positive electrode current collector, and the solid electrolyte layer provided on an upper portion of both surfaces of the positive electrode; and a structure 2-2 including a negative electrode including a negative electrode current collector and a negative electrode active material layer on both surfaces of the negative electrode current collector, and the solid electrolyte layer provided on both surfaces of the negative electrode, wherein the structure 1-1 and the structure 2-2 may be alternately and repeatedly laminated.

In an exemplary embodiment, the secondary battery may include a structure 1-3 including a positive electrode including a positive electrode current collector and a positive electrode active material layer on both surfaces of the positive electrode current collector, and the solid electrolyte layer provided on an upper portion of one surface of the positive electrode; and a structure 2-3 including a negative electrode including a negative electrode current collector and a negative electrode active material layer on both surfaces of the negative electrode current collector, and the solid electrolyte layer provided on one surface of the negative electrode, wherein the structure 1-3 and the structure 2-3 may be alternately and repeatedly laminated.

In an exemplary embodiment, the solid electrolyte layer may include 90 wt % or more of a solid electrolyte.

In an exemplary embodiment, the solid electrolyte layer may include a binder and/or a lithium salt.

In an exemplary embodiment, the secondary battery may further include a porous support between the electrode and the solid electrolyte layer.

In another general aspect, a method for manufacturing the secondary battery according to the exemplary embodiment includes: preparing the electrode including the current collector and the active material layer on at least any one surface of the current collector; and coating at least any one surface of the active material layer with a composition including a solid electrolyte.

In an exemplary embodiment, the coating with the composition including the solid electrolyte may be performed using a method of screen printing, nozzle scan, die casting, comma coating, slot die coating, aerosol spray coating, chemical vapor deposition, laminating, or gravure printing.

Other features and aspects will be apparent from the following detailed description, the drawings, and the claims.

### BRIEF DESCRIPTION OF THE DRAWINGS

FIG. 1 shows a structure including an electrode 40, a solid electrolyte layer 30, and an electrode lead 50.

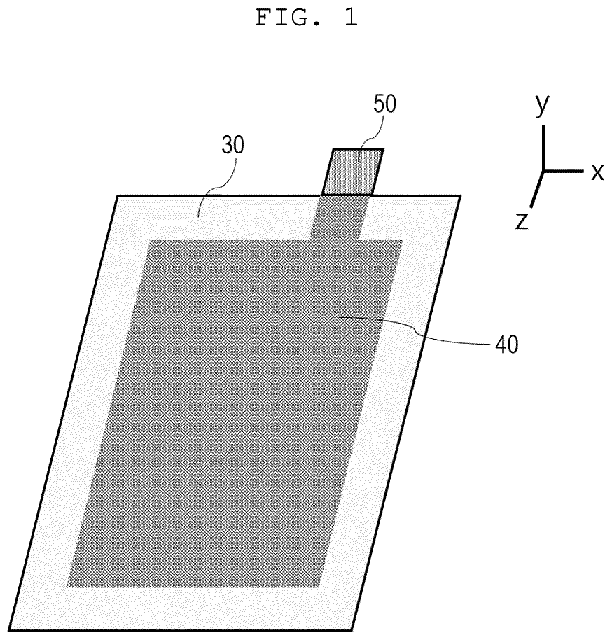

FIG. 2 shows an area (A_{ε}) of the electrode and an area (A_{S}) of the solid electrolyte layer described in the present disclosure, which are indicated on the electrode 40 and the solid electrolyte layer 30.

FIG. 3 shows an electrode structure according to an exemplary embodiment, which includes the solid electrolyte layer 30, and a positive electrode 10 including a positive electrode current collector 12 and a positive electrode active material layer 11. In the structure, D₁ is a thickness of the positive electrode 10, and D₂ is a thickness of the solid electrolyte layer 30.

FIG. 4 shows an electrode structure according to an exemplary embodiment, which includes the solid electrolyte layer 30, and a negative electrode 20 including a negative electrode current collector 22 and a negative electrode active material layer 21. In the structure, D₁ is a thickness of the negative electrode 20, and D₂ is a thickness of the solid electrolyte layer 30.

### [Detailed Description of Main Elements]

11: Positive electrode active material layer
12: Positive electrode current collector
21: Negative electrode active material layer
22: Negative electrode current collector
10: Positive electrode
20: Negative electrode
30: Solid electrolyte layer
40: Electrode
50: Electrode lead

### DETAILED DESCRIPTION OF EMBODIMENTS

Since the embodiments described in the present specification may be modified in many different forms, the technology according to an exemplary embodiment is not limited to the embodiments set forth herein. Furthermore, throughout the specification, unless otherwise particularly stated, the word “comprising”, “including”, “containing”, “being provided with”, or “having” does not mean the exclusion of any other constituent element, but rather means further inclusion of other constituent elements, and elements, materials, or processes which are not further listed are not excluded.

The numerical range used in the present specification includes all values within the range including the lower limit and the upper limit, increments logically derived from the form and breadth of a defined range, all double limited values, and all possible combinations of the upper limits and the lower limits in the numerical range defined in different forms. As an example, when it is defined that a content of a composition is 10% to 80% or 20% to 50%, it should be interpreted that a numerical range of 10% to 50% or 50% to 80% is also described in the specification of the present specification. Unless otherwise defined in the present specification, values which may be outside a numerical range due to experimental error or rounding off of a value are also included in the defined numerical range.

Unless otherwise defined in the present specification, “about” may be considered as a value within 30%, 25%, 20%, 15%, 10%, 5%, 3%, 2%, 1%, or 0.5% of a stated value.

Unless otherwise defined in the present specification, when it is said that a part such as a layer, a film, a thin film, a region, or a plate is “on” or “above” the other part, the part may be “directly on” the other part, and also, another part may intervene therebetween.

Hereinafter, the present disclosure will be described in detail (with reference to the accompanying drawings). However, it is only illustrative and the present disclosure is not limited to the specific embodiments which are illustratively described in the present disclosure.

A secondary battery according to an embodiment of the present disclosure includes: an electrode including a current collector, and an active material layer on at least any one surface of the current collector; and a solid electrolyte layer on at least any one surface of the active material layer, wherein a thickness (D₁) of the electrode and a thickness (D₂) of the solid electrolyte layer on any one surface of the active material layer satisfy the following Equation 1:

$${D}_{2} / {D}_{1} \leq 1.5 , \qquad [ Equation 1 ]$$

and an area (A_{ε}) of the active material layer on any one surface of the current collector and an area (A_{S}) of the solid electrolyte layer on any one surface of the active material layer satisfy the following Equation 2:

$$0.3 \leq {A}_{E} / {A}_{S} < 1. \qquad [ Equation 2 ]$$

In an exemplary embodiment, the electrode is a positive electrode 10 and/or a negative electrode 20, the positive electrode 10 includes a positive electrode current collector 12 and a positive electrode active material layer 11 provided on the positive electrode current collector 12, and the negative electrode 20 includes a negative electrode current collector 22 and a negative electrode active material layer 21 provided on the negative electrode current collector 22. In an exemplary embodiment, since the active material layer may be provided on at least any one surface of the current collector, it may be provided one or both surfaces of the current collector.

In an exemplary embodiment, since the solid electrolyte layer 30 may be provided on at least any one surface of the active material layer, when the active material layer is provided on both surfaces of the current collector, the solid electrolyte layer may be provided on only the active material layer provided on any one surface or provided on both active material layers provided on both surfaces.

In an exemplary embodiment, the thickness (D₂) of the solid electrolyte layer on any one surface of the active material layer may be 5 μm to 500 μm, 5 μm to 300 μm, 5 μm to 200 μm, 5 μm to 150 μm, or 10 μm to 100 μm, but is not necessarily limited thereto.

In an exemplary embodiment, the thickness (D₁) of the electrode may be 10 μm to 1,000 μm, 50 μm to 1,000 μm, 10 μm to 600 μm, 50 μm to 500 μm, or 50 μm to 200 μm, but is not necessarily limited thereto.

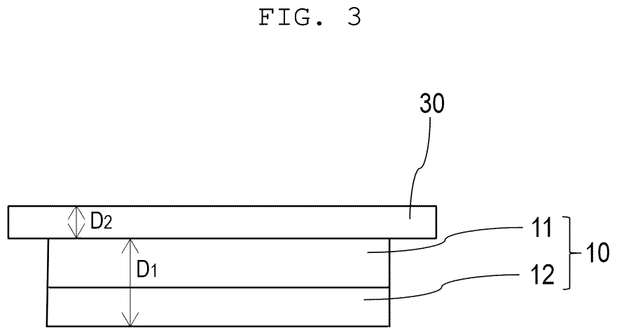

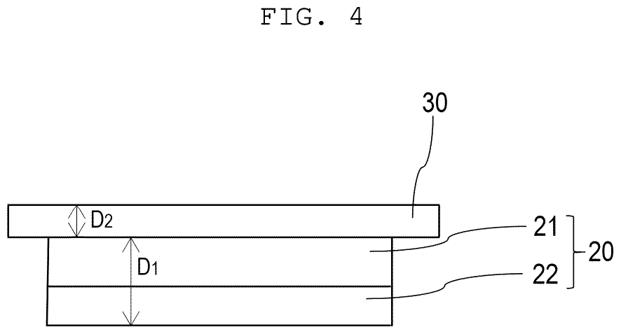

The thickness (D₁) of the electrode and the thickness (D₂) of the solid electrolyte layer may refer to the attached FIGS. 3 and 4. In an exemplary embodiment, a ratio of the thickness D₂/D₁ may satisfy the following Equation 1-1:

$$0.005 \leq {D}_{2} / {D}_{1} \leq 1.5 . \qquad [ Equation 1 - 1 ]$$

Otherwise, the ratio of the thickness D₂/D₁ may satisfy 0.005≤D₂/D₁≤1.0 (Equation 1-2), 0.008≤D₂/D₁≤ 1.3 (Equation 1-3), 0.008≤D₂/D₁≤1.0 (Equation 1-4), 0.01≤D₂/D₁≤1.0 (Equation 1-5), 0.005≤D₂/D₁≤0.5 (Equation 1-6), 0.01≤D₂/D₁≤0.1 (Equation 1-7), 0.005≤D₂/D₁≤0.05 (Equation 1-8), 0.001≤D₂/D₁≤1.5 (Equation 1-9), or 0.001≤D₂/D₁≤1.0 (Equation 1-10).

Without being bound to a specific theory, by satisfying the thickness ratio, the secondary battery of an exemplary embodiment may secure sufficient ion conductivity and energy density of a battery to improve battery performance, and also in a battery manufacturing process, may effectively prevent short circuit by a solid electrolyte layer.

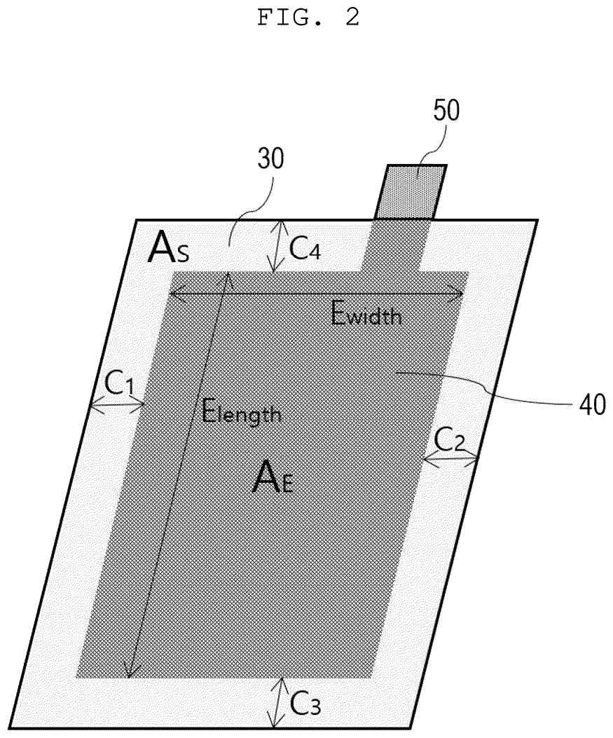

The area (A_{ε}) of the active material layer and the area (A_{S}) of the solid electrolyte layer may refer to the attached FIG. 2. In an exemplary embodiment, the area ratio A_{ε}/A_{S} may satisfy the following Equation 2-1:

$$0.4 \leq {A}_{E} / {A}_{S} < 1. \qquad [ Equation 2 - 1 ]$$

Otherwise, the area ratio A_{ε}/A_{S} may satisfy: 0.5≤A_{ε}/A_{S}<1 (Equation 2-2), 0.6≤A_{ε}/A_{S}<1 (Equation 2-3), 0.7≤A_{ε}/A_{S}<1 (Equation 2-4), 0.8≤A_{ε}/A_{S}<1 (Equation 2-5), or 0.9≤A_{ε}/A_{S}<1 (Equation 2-6).

Without being bound to a specific theory, by satisfying the area ratio, the secondary battery of an exemplary embodiment may secure sufficient ion conductivity and energy density of a battery to improve battery performance, and also in a battery manufacturing process, may effectively prevent short circuit by a solid electrolyte layer. When the area ratio exceeds the upper limit, an active material layer (or electrode) area where the solid electrolyte layer is not formed exists, and thus, it is not preferred in terms of ion conduction or electron conduction.

In an exemplary embodiment, the secondary battery may further satisfy the following Equation 3:

$$0.5 \leq ( {A}_{E} / {A}_{S} ) / ( {D}_{2} / {D}_{1} ) \leq 200. \qquad [ Equation 3 ]$$

Otherwise, the secondary battery may further satisfy: 0.5≤(A_{ε}/A_{S})/(D₂/D₁)≤150 (Equation 3-1), 0.5≤(A_{ε}/A_{S})/(D₂/D₁)≤120 (Equation 3-2), 1.0≤(A_{ε}/A_{S})/(D₂/D₁)≤ 150 (Equation 3-3), 5.0< (A_{ε}/A_{S})/(D₂/D₁)≤150 (Equation 3-4), 5.0≤(A_{ε}/A_{S})/(D₂/D₁)≤120 (Equation 3-5), or 5.0≤(A_{ε}/A_{S})/(D₂/D₁)≤100 (Equation 3-6). When the secondary battery according to an exemplary embodiment satisfies Equations 1 and 2 and also further satisfies Equation 3, further improved battery energy density may be implemented, and adhesion and durability of the solid electrolyte layer for an electrode may be improved.

According to an exemplary embodiment, in FIG. 2, E_{width} may be 20 mm to 80 mm, 20 mm to 60 mm, 30 mm to 60 mm, 40 mm to 50 mm, or about 45 mm, but is not limited thereto. E_{length} may be 20 mm to 80 mm, 20 mm to 60 mm, 30 mm to 60 mm, 40 mm to 60 mm, or about 50 mm, but is not limited thereto. C₁ to C₄ may be independently of one another 0.1 mm to 20 mm, 0.5 mm to 20 mm, 0.5 mm to 15 mm, 1 mm to 15 mm, or 2 mm to 10 mm, but is not limited thereto, and C₁ to C₄ may be identical to or different from one another.

In an exemplary embodiment, the solid electrolyte layer may be provided on an upper portion and a side portion of any one or both surfaces of the electrode (positive electrode and/or negative electrode), and more specifically, may be provided on the upper portion and the side portion of any one or both surfaces of the active material layer (positive electrode active material layer and/or negative electrode active material layer). The solid electrolyte layer according to an exemplary embodiment may be a free-standing solid electrolyte layer, and provided only on the active material layer or provided also on the side portion of the active material layer, in which the solid electrolyte layer may cover all of the side portion of the active material layer and cover only a part of the side portion of the active material layer. Even in the case in which the solid electrolyte layer is provided on the side portion of the electrode (or active material layer), the thickness (D₂) of the solid electrolyte layer is defined as the thickness of the solid electrolyte layer provided on the upper portion of the active material layer.

The secondary battery according to an exemplary embodiment may have a structure in which the electrode and the solid electrolyte layer are laminated repeatedly several times, and hereinafter, the specific embodiments will be described in detail.

A battery included in the secondary battery according to an exemplary embodiment may include a structure in which a structure 1-1 including a positive electrode 10 including a positive electrode e current collector and a positive electrode active material layer 11 on both surfaces of the positive electrode current collector 12, and the solid electrolyte layer 30 provided on an upper portion and/or a side portion of both surfaces of the positive electrode (specifically positive electrode active material layer); and a structure 2-1 including a negative electrode current collector and a negative electrode active material layer on both surfaces of the negative electrode current collector are alternately and repeatedly (once or more) laminated.

Otherwise, the secondary battery according to an exemplary embodiment may include a structure in which a structure 1-2 including a positive electrode current collector and a positive electrode active material layer on both surfaces of the positive electrode current collector; and a structure 2-2 including a negative electrode 20 including a negative electrode current collector 22 and a negative electrode active material layer 21 on both surfaces of the negative electrode current collector 22, and the solid electrolyte layer 30 provided on an upper portion and/or a side portion of both surfaces of the negative electrode (specifically negative electrode active material layer) are alternately and repeatedly (once or more) laminated.

Otherwise, the secondary battery according to an exemplary embodiment may include a structure in which a structure 1-1 including a positive electrode 10 including a positive electrode current collector 12 and a positive electrode active material layer 11 on both surfaces of the positive electrode current collector 12, and the solid electrolyte layer 30 provided on an upper portion and/or a side portion on both surfaces of the positive electrode (specifically positive electrode active material layer); and a structure 2-2 including a negative electrode 20 including a negative electrode current collector 22 and a negative electrode active material layer 21 on both surfaces of the negative electrode current collector 22, and the solid electrolyte layer 30 provided on an upper portion and/or a side portion on both surfaces of the negative electrode (specifically negative electrode active material layer) are alternately and repeatedly (once or more) laminated.

Otherwise, the secondary battery according to an exemplary embodiment may include a structure in which a structure 1-3 including a positive electrode 10 including a positive electrode current collector 12 and a positive electrode active material layer 11 on both surfaces of the positive electrode current collector 12, and the solid electrolyte layer 30 provided on an upper portion/side portion of one surface of the positive electrode (specifically positive electrode active material layer); and a structure 2-3 including a negative electrode 20 including a negative electrode current collector 22 and a negative electrode active material layer 21 on both surfaces of the negative electrode current collector 22, and the solid electrolyte layer 30 provided on an upper portion/side portion of one surface of the negative electrode (specifically negative electrode active material layer) are alternately and repeatedly (once or more) laminated. Herein, the lamination may be lamination so that the solid electrolyte layer is in contact with an active material layer of other structures which is not provided with the solid electrolyte layer.

In an exemplary embodiment, when the secondary battery includes a structure in which a structure satisfying Equation 1, Equation 2, and/or Equation 3 is/are repeatedly laminated, short circuit between unit cells may be effectively prevented by the solid electrolyte layer provided on the side portion of the electrode, and the interfacial resistance of the battery may be decreased.

In an exemplary embodiment, the solid electrolyte layer may include a sulfide-based solid electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is Ge, Zn or Ga), Li₂S—GeS₂, Li₂S—SiS₂—Li₃PO₄, Li₂S—SiS₂-LiₚMO_{q}, (p and q are positive numbers, and M is P, Si, Ge, B, Al, Ga, or In), Li₇₋ₓPS₆₋ₓClₓ (0≤x≤2), Li₇₋ₓPS₆₋ₓBrₓ (0≤x≤2), and/or Li₇₋ₓPS₆₋ₓIₓ (0≤x≤2). These may be used alone or in combination of two or more.

In an exemplary embodiment, the solid electrolyte layer may include an oxide-based solid electrolyte, and the oxide-based solid electrolyte may include a metal oxide or an ion conducting compound containing oxygen. The metal oxide may include, for example, Al₂O₃, ZnO₂, Ce₂O₃, TiO₂, ZrO₂, HfO₂, MnO₂, MgO, WO₂, and/or V₂O₅, but is not limited thereto.

The ion conducting compound containing oxygen may be, for example, a Garnet-based oxide, a LLZO (lithium lanthanum zirconium oxide; Li₇La₃Zr₂O₁₂)-based compound, a LLTO (Lithium lanthanum titanate)-based compound, Li₆La₂CaTa₂O₁₂, Li₆La₂ANb₂O₁₂ (A is Ca or Sr), Li₂Nd₃TeSbO₁₂, Li₃BO_{2.5}N_{0.5}, Li₉SiAlO₈, a LAGP (Lithium aluminium germanium phosphate)-based compound, a LATP (lithium aluminum titanium phosphate)-based compound, Li₁₊ₓTi₂₋ₓAlₓSi_{y}(PO₄)_{3-y} (0≤x≤1, 0≤y≤1), LiAlₓZr₂₋ₓ(PO₄)₃ (0≤x≤1, 0≤y≤1), LiTiₓZr₂₋ₓ(PO₄)₃ (0≤x≤1, 0≤y≤1), a LISICON (lithium super ionic conductor)-based (type) compound, a LIPON (lithium phosphorus oxynitride)-based compound, a NASICON (sodium super ionic conductor)-based compound, a Garnet-based compound, or a perovskite-based compound, but is not limited thereto.

The NASICON-based compound may be, for example, Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y<3), Li_{1+x+y}(Al, Ga)ₓ(Ti, Ge)₂₋ₓSi_{y}P_{3-y}O₁₂ (0≤x≤1, 0≤y≤1), or Li₂O—Al₂O₃—SiO₂—P₂O₅—TiO₂—GeO₂, but is not limited thereto.

The Garnet-based compound may be, for example, Li₃₊ₓLa₃M₂O₁₂ (M=Te, Nb, or Zr), Li_{7-y}La₃₋ₓAₓZr_{2-y}M_{y}O₁₂ (A=Y, Nd, Sm, or Gd; 0<x<3; M=Nb or Ta; 0<y<2), but is not limited thereto.

The perovskite-based compound may be, for example, Li₃La_{2/(3-x)}TiO₃ (LLTO) or Li₃₋ₓPO₄₋ₓNₓ (LIPON), but is not limited thereto.

In an exemplary embodiment, the solid electrolyte may have an amorphous structure, and for example, may be LIPON (Li₃₋ₓPO₄₋ₓNₓ), Li₂O—B₂O₃—P₂O₅, Li₂O—SiO₂, Li₂O—B₂O₃, or Li₂O—B₂O₃—ZnO, but is not limited thereto.

In an exemplary embodiment, the solid electrolyte layer may include 90 wt % or more of a solid electrolyte. Otherwise, the solid electrolyte layer may include 90 wt % to 99 wt % or 90 wt % to 95 wt % of the solid electrolyte. Specifically, the solid electrolyte layer may include 90 wt % or more, 90 wt % to 99 wt %, or 90 wt % to 95 wt % of the oxide-based solid electrolyte.

In an exemplary embodiment, the solid electrolyte layer may include a binder. For example, the binder may be appropriately bound to solid electrolyte particles, may be appropriately those capable of improving adhesive strength to an electrode of a slurry for forming a solid electrolyte layer, and may include, for example, at least one selected from the group consisting of polyvinylidene fluoride (PVDF), poly(vinylidene fluoride-co-hexafluoropropylene (PVDF-HFP), polyacrylonitrile, polymethylmethacrylate, acrylonitrile butadiene rubber (NBR), polybutadiene rubber (BR), styrene-butadiene rubber (SBR), polyacrylic resin, ethyl-cellulose, methyl cellulose, polyvinyl butyral resin, polyvinylidene fluoride, alkyl ester carboxylate, and ethylenic unsaturated carboxylic acid monomer, but is not limited thereto. The binder may be included at 0.1 wt % to 30 wt % with respect to the weight of the solid content of the slurry.

In an exemplary embodiment, the slurry for forming a solid electrolyte layer may further include a solvent. The solvent is not particularly limited, but for example, may be one or more solvents selected from the group consisting of terpineol, alcohol, ketone, amide, ester, ether, and carbonate-based solvents. An amount of the solvent used is not particularly limited, but for example, the solvent may be used so that a weight ratio between the solid content and the solvent is 30 to 40:60 to 70 with respect to the total weight of the slurry.

In an exemplary embodiment, the solid electrolyte layer may further include a lithium salt. The lithium salt may be selected from, for example, LiPF₆, LiClO₄, LiBF₄, LiFSI, LiTFSI, LiSO₃CF₃, LiBOB, LiFOB, LiDFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LIC(CF₃SO₂)₃, or a combination thereof, but is not necessarily limited thereto. In an exemplary embodiment, the solid electrolyte layer or the slurry for forming a solid electrolyte layer may include the lithium salt within about 10 wt % or less.

The secondary battery according to an exemplary embodiment may further include a porous support between the electrode and the solid electrolyte layer. The porous support may include, for example, a porous film including a cellulose-based polymer, fiber, non-woven fabric, a mesh-type membrane, or a polyolefin-based resin, but is not necessarily limited thereto.

In an exemplary embodiment, a thickness of the porous support is not particularly limited, but may be about 30 μm or less, and specifically, 1 μm to 30 μm, 5 μm to 30 μm, or 10 μm to 30 μm. In an exemplary embodiment, a porosity of the porous support may be, though is not particularly limited, about 80% or less, specifically, 30% to 80%, 50% to 80%, or 60% to 70%. Meanwhile, according to an embodiment of the present disclosure, a battery having high energy density and improved stability may be provided without including the porous support, of course.

The secondary battery according to an exemplary embodiment may not include a separator. The secondary battery according to an exemplary embodiment may effectively prevent short circuit between a positive electrode and a negative electrode by the solid electrolyte layer provided on the upper portion and/or the side portion of the electrode without including the separator.

In an exemplary embodiment, the secondary battery may be a lithium secondary battery.

Another embodiment of the present disclosure provides a method for manufacturing the secondary battery according to the exemplary embodiment including: preparing the electrode including the current collector and the active material layer on at least any one surface of the current collector; and coating at least any one surface of the active material layer with a composition including a solid electrolyte.

Specifically, the method for manufacturing a secondary battery according to an embodiment including: preparing the positive electrode the positive electrode active material layer provided on any one surface or both surfaces of the positive electrode current collector; preparing the negative electrode having the negative electrode active material layer provided on any one or both surfaces of the negative electrode current collector; and coating the upper portion and/or the side portion of any one or both surfaces of any one or more electrodes (specifically negative electrode active material layer and/or positive electrode active material layer) of the positive electrode and the negative electrode with the composition including the solid electrolyte (slurry for forming a solid electrolyte layer) is provided.

Since the above description of the secondary battery may be identically applied to the method for manufacturing a secondary battery, description will be omitted for the same content.

In an exemplary embodiment, the step of coating with the composition including the solid electrolyte may be performed using a method of screen printing, nozzle scan, die casting, comma coating, slot die coating, aerosol spray coating, chemical vapor deposition, laminating, or gravure printing, and specifically, may be performed using screen printing, but is not necessarily limited thereto.

### [Positive Electrode]

The positive electrode 10 may include a positive electrode current collector 12 and a positive electrode active material layer 11 placed on at least one surface of the positive electrode current collector.

### (Positive Electrode Current Collector)

The positive electrode current collector may include stainless steel, nickel, aluminum, titanium, or an alloy thereof. The positive electrode current collector may also include aluminum or stainless steel which is surface-treated with carbon, nickel, titanium, or silver.

### (Positive Electrode Material)

The positive electrode active material layer may include a positive electrode active material. The positive electrode active material may include a compound which may reversibly intercalate and deintercalate lithium ions.

According to illustrative examples, the positive electrode active material may include a lithium-nickel metal oxide. The lithium-nickel metal oxide may further include at least one of cobalt (Co), manganese (Mn), and aluminum (Al).

In some exemplary embodiments, the positive electrode active material or the lithium-nickel metal oxide may include a layered structure or a crystal structure represented by the following Chemical Formula 1:

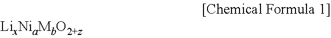

wherein 0.9≤x≤1.2, 0.6≤a≤0.99, 0.01≤b≤0.4, and −0.5≤z≤0.1; and as described above, M may include Co, Mn, and/or Al.

The chemical structure represented by Chemical Formula 1 shows a bonding relationship included in the layered structure or the crystal structure of the positive electrode active material, but other additional elements are not excluded. For example, M includes Co and/or Mn, and Co and/or Mn may be provided as a main active element of the positive electrode active material with Ni. Chemical Formula 1 is provided for expressing the bonding relationship of the main active elements and should be understood as a formula covering introduction of or substitution with an additional element.

In an exemplary embodiment, auxiliary elements which are added to the main active elements to enhance chemical stability of the positive electrode active material or the layered structure/crystal structure may be further included. The auxiliary element may be incorporated into the layered structure/crystal structure to form a bond, and in this case also, should be understood to be included in the range of the chemical structure represented by Chemical Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element may act as, for example, an auxiliary active element which contributes to the capacity/output activity of the positive electrode active material with Co or Mn, like Al.

For example, the positive electrode active material or the lithium-nickel metal oxide may include a layered structure or a crystal structure represented by the following Chemical Formula 1-1:

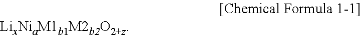

wherein M1 may include Co, Mn, and/or Al; M2 may include the auxiliary element described above; and 0.9≤x≤1.2, 0.3≤a≤0.99, 0.01≤b1+b2≤0.7, and −0.5≤z≤0.1.

The positive electrode active material may further include a coating element or a doping element. For example, elements which are substantially identical or similar to the auxiliary elements described above may be used as a coating element or a doping element. For example, among the elements described above, a single element or a combination of two or more elements may be used as a coating element or a doping element.

The coating element or the doping element may be present on the surface of the lithium-nickel metal oxide particles or may penetrate through the surface of the lithium-nickel metal composite oxide particles and be included in the combined structure represented by Chemical Formula 1 or Chemical Formula 1-1.

The positive electrode active material may include a nickel-cobalt-manganese (NCM)-based lithium oxide. In this case, an NCM-based lithium oxide having an increased nickel content may be used.

Ni may be provided as a transition metal related to the output and capacity of a lithium secondary battery. Therefore, as described above, since a high-content (high-Ni) composition is adopted into the positive electrode active material, a high-capacity positive electrode and a high-capacity secondary battery may be provided.

However, as the content of Ni increases, the long-term preservation stability and the life stability of the positive electrode or the secondary battery may be relatively reduced, and a side reaction with an electrolyte may be increased. However, according to illustrative examples, the life stability and the capacity retention properties may be improved by Mn, while maintaining the electrical conductivity by including Co.

The content of Ni in the NCM-based lithium oxide (for example, the mole fraction of nickel of the total moles of nickel, cobalt, and manganese) may be 0.6 or more, 0.7 or more, or 0.8 or more. In some exemplary embodiments, the content of Ni may be 0.8 to 0.95, 0.82 to 0.95, 0.83 to 0.95, 0.84 to 0.95, 0.85 to 0.95, or 0.88 to 0.95.

In some exemplary embodiments, the positive electrode active material may include a lithium cobalt oxide-based active material, a lithium manganese oxide-based active material, a lithium nickel oxide-based active material, or a lithium iron phosphate (LFP)-based active material (for example, LiFePO₄).

In some exemplary embodiments, the positive electrode active material may include a Mn-rich-based active material having a chemical structure or crystal structure represented by Chemical Formula 2, a Li rich layered oxide (LLO)/over lithiated oxide (OLO)-based active material, or a Co-less-based active material:

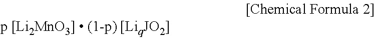

wherein 0<p<1 and 0.9≤q≤1.2; and J may include at least one element of Mn, Ni, Co, Fe, Cr, V, Cu, Zn, Ti, Al, Mg, and B.

### (Method for Manufacturing Positive Electrode)

For example, the positive electrode active material may be mixed into the solvent to prepare a positive electrode slurry. After coating the positive electrode current collector with the positive electrode slurry, drying and rolling may be performed to manufacture a positive electrode active material layer. The coating process may be performed by a method such as gravure coating, slot die coating, multilayer simultaneous die coating, imprinting, doctor blade coating, dip coating, bar coating, and casting, but is not limited thereto. The positive electrode active material layer may further include a binder, and may optionally further include a conductive material, a thickener, and the like.

### (Positive Electrode Solvent)

A non-limiting example of the solvent used for preparation of the positive electrode active material layer may include N-methyl-2-pyrrolidone (NMP), dimethyl formamide, dimethyl acetamide, N, N-dimethylaminopropylamine, ethylene oxide, tetrahydrofuran, and the like.

### (Positive Electrode Binder)

The binder may include polyvinylidene fluoride (PVDF), poly(vinylidene fluoride-co-hexafluoropropylene (PVDF-HFP), polyacrylonitrile, polymethyl methacrylate, acrylonitrile butadiene rubber (NBR), polybutadiene rubber (BR), styrene-butadiene rubber (SBR), and the like. In an exemplary embodiment, a PVDF-based binder may be used as a positive electrode binder.

### (Positive Electrode Conductive Material)

The conductive material may be added for increasing conductivity of the positive electrode active material layer and/or mobility of lithium ions or electrons. For example, the conductive material may include carbon-based conductive materials such as graphite, carbon black, acetylene black, ketjen black, graphene, carbon nanotubes, vapor-grown carbon fiber (VGCF), carbon fiber, and carbon nanofiber, and/or metal-based conductive materials including tin, tin oxide, titanium oxide, perovskite materials such as LaSrCoO₃ and LaSrMnO₃, and the like, but is not limited thereto.

### (Positive Electrode Thickener/Dispersant)

If necessary, the positive electrode active material layer may further include a thickener and/or a dispersant and the like. As an exemplary embodiment, the positive electrode active material layer may include a thickener such as carboxymethyl cellulose (CMC).

### [Negative Electrode]

The negative electrode 20 may include a negative electrode current collector 22 and a negative electrode active material layer 21 placed on at least one surface of the negative electrode current collector.

### (Negative Electrode Current Collector)

A non-limiting example of the negative electrode current collector may include a copper foil, a nickel foil, a stainless-steel foil, a titanium foil, a nickel foam, a copper foam, a polymer substrate coated with a conductive metal, and the like.

### (Negative Electrode Material)

The negative electrode active material layer may include a negative electrode active material. As the negative electrode active material, a material capable of adsorbing or desorbing lithium ions may be used. For example, the negative electrode active material may be a carbon-based material such as crystalline carbon, amorphous carbon, carbon composite, and carbon fiber; lithium metal; lithium alloy; a silicon (Si)-containing material, a tin (Sn)-containing material, or the like.

An example of the amorphous carbon may include hard carbon, soft carbon, coke, mesocarbon microbead (MCMB), mesophase pitch-based carbon fiber (MPCF), and the like.

An example of the crystalline carbon may include graphite-based carbon such as natural graphite, artificial graphite, graphitized coke, graphitized MCMB, and graphitized MPCF.

The lithium metal may include a pure lithium metal or a lithium metal on which a protective layer for suppressing dendrite growth and the like is formed. In an exemplary embodiment, a lithium metal-containing layer which is deposited or coated on a negative electrode current collector may be used as a negative electrode active material layer. In an exemplary embodiment, a lithium thin film layer may be used as a negative electrode active material layer.

An element included in the lithium alloy may include aluminum, zinc, bismuth, cadmium, antimony, silicon, lead, tin, gallium, indium, or the like.

The silicon-containing material may provide more increased capacity characteristics. The silicon-containing material may include Si, SiOₓ (0<x<2), metal-doped SiOₓ (0<x<2), a silicon-carbon composite, and the like. The metal may include lithium and/or magnesium, and the metal-doped SiOₓ (0<x<2) may include metal silicate.

### (Method for Manufacturing Negative Electrode)

For example, the negative electrode active material may be mixed into the solvent to prepare a negative electrode slurry. After coating/depositing the negative electrode slurry on the negative electrode current collector, drying and rolling may be performed to manufacture a negative electrode active material layer. The coating process may be performed by a method such as gravure coating, slot die coating, multilayer simultaneous die coating, imprinting, doctor blade coating, dip coating, bar coating, and casting, but is not limited thereto. The negative electrode active material layer may further include a binder, and may optionally further include a conductive material, a thickener, and the like.

In some exemplary embodiments, the negative electrode may include a negative electrode active material layer in a lithium metal form formed by a deposition/coating process.

### (Negative Electrode Solvent)

A non-limiting example of the solvent for the negative electrode active material may include water, pure water, deionized water, distilled water, ethanol, isopropanol, methanol, acetone, n-propanol, t-butanol, and the like.

### (Negative Electrode Binder/Conductive Material/Thickener)

As the binder, the conductive material, and the thickener, the materials described above, which may be used in the manufacture of the positive electrode, may be used.

In some exemplary embodiments, a styrene-butadiene rubber (SBR)-based binder, carboxymethyl cellulose (CMC), a polyacrylic acid-based binder, a poly(3,4-ethylenedioxythiophene) (PEDOT)-based binder, and the like may be used as a negative electrode binder.

### [Electrode Assembly]

According to exemplary embodiments, the positive electrode, the negative electrode, and the solid electrolyte layer may be repeatedly disposed to form an electrode assembly. In some exemplary embodiments, the electrode assembly may be a winding type, a stacking type, a zigzag (z)-folding type, or a stack-folding type.

### [Cell Structure]

For example, electrode tabs (positive electrode tab and negative electrode tab) may protrude from the positive electrode current collector and the negative electrode current collector and extend to one side of a case, respectively. The electrode tabs may be connected to electrode leads (positive electrode lead and negative electrode lead) which are fused with the one side of the case and extended or exposed to the outside of the case.

For example, a pouch-type case, an angular case, a cylindrical case, a coin-type case, and the like may be used.

Hereinafter, the examples will be further described with reference to the specific experimental examples. It is apparent to those skilled in the art that the examples and the comparative examples included in the experimental examples only illustrate an embodiment and do not limit the appended claims, and various modifications and alterations of the examples may be made within the range of the scope and spirit of the present disclosure, and these modifications and alterations will fall within the appended claims.

### Example 1

### (1) Manufacture of First Electrode Structure

Li[Ni_{0.8}Co_{0.1}Mn_{0.1}]O₂ as an active material, carbon black as a conductive material, and polyvinylidene fluoride (PVdF) as a binder were mixed at a weight ratio of 95:2.5:2.5 to prepare a slurry for a first electrode. Next, the slurry for a first electrode was cast on an aluminum foil having a thickness of 12 μm and then dried under vacuum at 120° C. The dried positive electrode active material layer was rolled, and then cut into a length of about 45 mm×50 mm to prepare a first electrode (positive electrode) having a thickness of about 0.1 mm (area: 2250 mm²).

Next, 99 wt % of α-terpineol and 1 wt % of ethyl cellulose were first stirred at 3,000 rpm with a paste mixer (Thinky Corp.) for 5 minutes to prepare a first slurry. Next, a Garnet-based oxide solid electrolyte (LLZO) and the first slurry were weighed at a weight ratio of 1:1 and added, and stirred for the second time at 3,000 rpm with the paste mixer (Thinky Corp.) for 5 minutes to prepare a solid electrolyte composition. Thereafter, the prepared composition for a solid electrolyte was directly cast on the positive electrode using a screen printer to form a solid electrolyte layer. At this time, the thickness of the solid electrolyte layer was 0.01 mm, and E_{width}, E_{length}, C₁, C₂, C₃, and C₄ indicated in the following FIG. 2 are shown in the following Table 2, respectively.

### (2) Manufacture of Second Electrode Structure

Natural graphite as an active material, carbon black as a conductive material, and CMC/SBR as a binder were mixed at a weight ratio of 96:1:3 to prepare a slurry for a second electrode. Next, the slurry for a second electrode was cast on a copper foil having a thickness of 10 μm and then dried under vacuum at 120° C. The dried negative electrode active material layer was rolled, and then cut into a length of about 45 mm×50 mm to prepare a second electrode (negative electrode) having a thickness of about 0.1 mm (area: 2250 mm²).

Next, 99 wt % of α-terpineol and 1 wt % of ethyl cellulose were first stirred at 3,000 rpm with a paste mixer (Thinky Corp.) for 5 minutes to prepare a first slurry. Next, a Garnet-based oxide solid electrolyte (LLZO) and the first slurry were weighed at a weight ratio of 1:1 and added, and stirred for the second time at 3,000 rpm with the paste mixer (Thinky Corp.) for 5 minutes to prepare a solid electrolyte composition. Thereafter, the prepared composition for a solid electrolyte was directly cast on the negative electrode using a screen printer to form a solid electrolyte layer.

At this time, the thickness of the solid electrolyte layer was 0.01 mm, and E_{width}, E_{length}, C₁, C₂, C₃, and C₄ indicated in the following FIG. 2 are shown in the following Table 2, respectively.

### (3) Manufacture of Lithium Battery

The first electrode structure and the second electrode structure manufactured above were sequentially laminated to manufacture an electrode structure and then assembled in a pouch cell outer material.

### Examples 2 to 5

Batteries were manufactured in the same manner as in Example 1, except that D₁, D₂, E_{width}, E_{length}, C₁, C₂, C₃, and C₄ were as shown in the following Tables 1 and 2.

### Comparative Examples 1 to 4

Batteries were manufactured in the same manner as in Example 1, except that D₁, D₂, E_{width}, E_{length}, C₁, C₂, C₃, and C₄ were as shown in the following Tables 1 and 2.

TABLE 1

| | Thickness of electrode | | |
|---|---|---|---|
| | (positive electrode | Thickness of solid | |
| | and negative | electrolyte layer | |
| | electrode) (D₁, mm) | (D₂, mm) | D₂/D₁ |
| Example 1 | 0.1 | 0.01 | 0.1 |
| Example 2 | 0.1 | 0.01 | 0.1 |
| Example 3 | 0.1 | 0.10 | 1.0 |
| Example 4 | 0.1 | 0.01 | 0.1 |
| Example 5 | 1.0 | 0.01 | 0.01 |
| Comparative | 0.1 | 0.20 | 2.0 |
| Example 1 | | | |
| Comparative | 0.1 | 0.20 | 2.0 |
| Example 2 | | | |
| Comparative | 0.1 | 0.10 | 1.0 |
| Example 3 | | | |
| Comparative | 0.1 | 0.17 | 1.7 |
| Example 4 | | | |

TABLE 2

| | E_{width} | E_{length} | C₁ | C₂ | C₃ | C₄ |
|---|---|---|---|---|---|---|
| | (mm) | (mm) | (mm) | (mm) | (mm) | (mm) |
| Example 1 | 45 | 50 | 2 | 2 | 2 | 2 |
| Example 2 | 45 | 50 | 5 | 5 | 5 | 5 |
| Example 3 | 45 | 50 | 2 | 2 | 2 | 2 |
| Example 4 | 45 | 50 | 10 | 10 | 10 | 10 |
| Example 5 | 45 | 50 | 2 | 2 | 2 | 2 |
| Comparative | 45 | 50 | 10 | 10 | 10 | 10 |
| Example 1 | | | | | | |
| Comparative | 45 | 50 | 25 | 25 | 25 | 25 |
| Example 2 | | | | | | |
| Comparative | 45 | 50 | 25 | 25 | 25 | 25 |
| Example 3 | | | | | | |
| Comparative | 45 | 50 | 10 | 10 | 10 | 10 |
| Example 4 | | | | | | |

TABLE 3

| | A_{E} (mm²) | A_{S} (mm²) | A_{E}/A_{S} |
|---|---|---|---|
| Example 1 | 2250 | 2646 | 0.85 |
| Example 2 | 2250 | 3300 | 0.68 |
| Example 3 | 2250 | 2646 | 0.85 |
| Example 4 | 2250 | 4550 | 0.49 |
| Example 5 | 2250 | 2646 | 0.85 |
| Comparative Example 1 | 2250 | 4550 | 0.49 |
| Comparative Example 2 | 2250 | 9500 | 0.24 |
| Comparative Example 3 | 2250 | 9500 | 0.24 |
| Comparative Example 4 | 2250 | 4550 | 0.49 |

### Experimental Example

The energy densities of the batteries manufactured in the examples and the comparative examples were calculated based on only the area and the thickness of the electrode structure including the electrode and the solid electrolyte layer excluding the apparatus and materials such as a pouch and a lead tap among the battery components, and the specific calculation formula was as follows. The capacity per area of the positive electrode was based on 4.0 mAh/cm², and as the thickness increased, the energy density was calculated proportionally thereto. The results are shown in the following Table 4.

$$Energy density ( Wh / L ) = \{ ( electrode area ) \times ( capacity per area of electrode ) \times ( average voltage ) \} / ( battery volume )$$

TABLE 4

| | D₂/D₁ | A_{E}/A_{S} | Energy density |
|---|---|---|---|
| Example 1 | 0.1 | 0.85 | 564.32 |
| Example 2 | 0.1 | 0.68 | 452.48 |
| Example 3 | 1.0 | 0.85 | 310.37 |
| Example 4 | 0.1 | 0.49 | 328.17 |
| Example 5 | 0.01 | 0.85 | 614.60 |
| Comparative Example 1 | 2.0 | 0.49 | 120.33 |
| Comparative Example 2 | 2.0 | 0.24 | 56.69 |
| Comparative Example 3 | 1.0 | 0.24 | 85.04 |
| Comparative Example 4 | 1.7 | 0.49 | 133.70 |

As confirmed from the above Table 4, when the ratio (D₂/D₁) between the thickness (D₂) of the solid electrolyte layer and the thickness (D₁) of the electrode was 1.5 or less, and the ratio (Ag/A_{S}) between the area (A_{ε}) of the electrode and the area (A_{S}) of the solid electrolyte layer was less than 1, the energy density of the battery was significantly improved. In addition, when the thickness and the area ratios were not satisfied as in the comparative example, adhesive strength of the solid electrolyte layer to the upper portion and/or the side portion of the electrode was low, so that there was a risk of releasing the electrolyte from the side portion of the electrode.

Furthermore, it was confirmed that in the step of manufacturing the solid electrolyte layer of Example 1, as a result of covering the electrode with the porous support such as non-woven fabric and then forming the solid electrolyte layer on the support (Example 6), the adhesive strength between the side portion of the electrode and the solid electrolyte became stronger, while maintaining battery performance at the same level.

An embodiment relates to a secondary battery including a structure in which a solid electrolyte layer having a thickness and an area satisfying a specific ratio range is provided on an upper portion of an electrode. The secondary battery according to an exemplary embodiment may effectively prevent short circuit between electrodes and/or between unit cells while also allowing thinning of the solid electrolyte layer at the same time, and also may improve battery performance of the secondary battery.

The above description is only an example to which the principle of the present disclosure is applied, and other constitutions may be further included without departing from the scope of the present disclosure. Hereinabove, though an implementation has been described in detail by the examples and the experimental examples, the scope of an implementation is not limited to specific examples and should be construed by the appended claims.

What is claimed is:

1. A secondary battery comprising:
an electrode including a current collector, and an active material layer on at least any one surface of the current collector; and
a solid electrolyte layer on at least any one surface of the active material layer,
wherein a thickness (D₁) of the electrode and a thickness (D₂) of the solid electrolyte layer on any one surface of the active material layer satisfy the following Equation 1:
$${D}_{2} / {D}_{1} \leq 1.5 , \qquad [ Equation 1 ]$$
and an area (A_{ε}) of the active material layer on any one surface of the current collector and an area (A_{S}) of the solid electrolyte layer on any one surface of the active material layer satisfy the following Equation 2:
$$0.3 \leq {A}_{E} / {A}_{S} < 1. . \qquad [ Equation 2 ]$$

2. The secondary battery of claim 1, wherein the thickness (D₂) of the solid electrolyte layer on any one surface of the active material layer is 5 μm to 500 μm.

3. The secondary battery of claim 1, wherein the thickness (D₁) of the electrode is 10 μm to 1,000 μm.

4. The secondary battery of claim 1, wherein the thickness (D₁) of the electrode and the thickness (D₂) of the solid electrolyte layer on any one surface of the active material layer satisfy the following Equation 1-1:
$$0.005 \leq {D}_{2} / {D}_{1} \leq 1.5 . \qquad [ Equation 1 - 1 ]$$

5. The secondary battery of claim 1, wherein the thickness (D₁) of the electrode and the thickness (D₂) of the solid electrolyte layer on any one surface of the active material layer satisfy the following Equation 1-2:
$$0.005 \leq {D}_{2} / {D}_{1} \leq 1. . \qquad [ Equation 1 - 2 ]$$

6. The secondary battery of claim 1, wherein the area (A_{ε}) of the active material layer on any one surface of the current collector and the area (A_{S}) of the solid electrolyte layer on any one surface of the active material layer satisfy the following Equation 2-1:
$$0.4 \leq {A}_{E} / {A}_{S} < 1. . \qquad [ Equation 2 - 1 ]$$

7. The secondary battery of claim 1, wherein the following Equation 3 is further satisfied:
$$0.5 \leq ( {A}_{E} / {A}_{S} ) / ( {D}_{2} / {D}_{1} ) \leq 200. \qquad [ Equation 3 ]$$

8. The secondary battery of claim 1, wherein the solid electrolyte layer is provided on an upper portion and a side portion of any one surface or both surfaces of the electrode.

9. The secondary battery of claim 1, wherein the secondary battery includes:
a structure 1-1 including a positive electrode including a positive electrode current collector and a positive electrode active material layer on both surfaces of the positive electrode current collector, and the solid electrolyte layer on both surfaces of the positive electrode; and
a structure 2-1 including a negative electrode current collector and a negative electrode active material layer on both surfaces of the negative electrode current collector,
wherein the structure 1-1 and the structure 2-1 are alternately and repeatedly laminated.

10. The secondary battery of claim 1, wherein the secondary battery includes:
a structure 1-2 including a positive electrode current collector and a positive electrode active material layer on both surfaces of the positive electrode current collector; and
a structure 2-2 including a negative electrode including a negative electrode current collector and a negative electrode active material layer on both surfaces of the negative electrode current collector, and the solid electrolyte layer on both surfaces of the negative electrode,
wherein the structure 1-2 and the structure 2-2 are alternately and repeatedly laminated.

11. The secondary battery of claim 1, wherein the secondary battery includes:
a structure 1-1 including a positive electrode including a positive electrode current collector and a positive electrode active material layer on both surfaces of the positive electrode current collector, and the solid electrolyte layer on both surfaces of the positive electrode; and
a structure 2-2 including a negative electrode including a negative electrode current collector and a negative electrode active material layer on both surfaces of the negative electrode current collector, and the solid electrolyte layer on both surfaces of the negative electrode,
wherein the structure 1-1 and the structure 2-2 are alternately and repeatedly laminated.

12. The secondary battery of claim 1, wherein the secondary battery includes:
a structure 1-3 including a positive electrode including a positive electrode current collector and a positive electrode active material layer on both surfaces of the positive electrode current collector, and the solid electrolyte layer on one surface of the positive electrode; and
a structure 2-3 including a negative electrode including a negative electrode current collector and a negative electrode active material layer on both surfaces of the negative electrode current collector, and the solid electrolyte layer on one surface of the negative electrode,
wherein the structure 1-3 and the structure 2-3 are alternately and repeatedly laminated.

13. The secondary battery of claim 1, wherein the solid electrolyte layer includes 90 wt % or more of a solid electrolyte.

14. The secondary battery of claim 1, wherein the solid electrolyte layer includes a binder.

15. The secondary battery of claim 1, wherein the solid electrolyte layer includes a lithium salt.

16. The secondary battery of claim 1, further comprising a porous support between the electrode and the solid electrolyte layer.

17. A method for manufacturing the secondary battery of claim 1, the method comprising:
preparing the electrode including the current collector and the active material layer provided on at least any one surface of the current collector; and
coating at least any one surface of the active material layer with a composition including a solid electrolyte.

18. The method of claim 17, wherein the coating with the composition including the solid electrolyte is performed using a method of screen printing, nozzle scan, die casting, comma coating, slot die coating, aerosol spray coating, chemical vapor deposition, laminating, or gravure printing.
